(19) United States
(12) Patent Application Publication
(10) Pub. No.: US 2006/0140994 A1
(43) Pub. Date: Jun. 29, 2006

(54) Application of an antimicrobial agent on an elastomeric article

(76) Inventors: Alison S. Bagwell, Cumming, GA (US); David W. Koenig, Menasha, WI (US); Martin S. Shamis, Alpharetta, GA (US); Jali L. Williams, Phoenix, AZ (US)

Correspondence Address: KIMBERLY-CLARK WORLDWIDE, INC., 401 NORTH LAKE STREET, NEENAH, WI, 54956, US

(21) Appl. No.: 11/023,201

(22) Filed: Dec. 27, 2004

(51) Int. Cl. A01N 25/34

(52) U.S. Cl. 424/404

(57) ABSTRACT

An elastomeric article having reducing microbe affinity and transmission and methods for applying and immobilizing antimicrobial compounds to the elastomeric substrate surface are disclosed. The elastomeric article has a body formed of a natural or synthetic polymer latex having an outer surface and an inner surface. The body has a coating of an antimicrobial agent over at least a portion of said outer surface. The treatment involves applying according to either a spraying or dipping process an antimicrobial polymer or composition to a surface of the elastomeric substrate; binding the antimicrobial composition to the surface in a manner such that said treat antimicrobial coating passes either one or another or both versions of a zone of inhibition test, such test including: a) a dry-leaching or agar-plate-based contact test, according to AATCC 147 protocol, or b) a wet-leaching or dynamic shake flask test according to ASTM E-2149-01 protocol. The substrate is further subject to a rapid germicidal contact-transfer test of relatively short duration. The antimicrobial polymer can include an organosilane quaternary ammonium or a biguanide compound which can disrupt the ionic charges of microbial cellular membranes.

### FIELD OF THE INVENTION

The present invention relates to elastomeric articles that have a non-leaching antimicrobial agent applied and stably associated to their surfaces.

### BACKGROUND

A variety of elastomeric articles traditionally have been produced from natural and synthestic-material polymers, such as polyisoprene, nitrile rubber, vinyl (polyvinylchloride), polychloroprene or polyurethane materials, partially because of the good moldability, processibility, and physical properties upon curing of these materials. Elastomeric articles can be adapted for various kinds of applications, such as in clinical, laboratory, or medical settings, or manufacturing and other industrial uses. The ability of an elastomeric article to deform and recover substantially its original shape when released, after being stretched several times their original length, is an advantage. In addition to having high elasticity, nature rubber and synthetic lattices also provide good strength and good barrier properties, which are attractive and important features. Good barrier properties, which can be made impermeable not only to aqueous solutions, but also many solvents and oils, can provide an effective protection between a wearer and the environment, successfully protecting both from cross-contamination.

As the demand for good barrier-control has increase and expanded in many areas of daily life, the use of articles made from elastomeric materials has likewise increased and expanded. For instance, in the area of medical or surgical products, including surgical, examination or work gloves, prophylactics, condoms, catheters, balloons, tubing or other devices, and the like, which may be used in biological, chemical, or pharmaceutical research, and laboratory, clinical, or diagnostic settings, maintaining good barrier protection has been important. Guidelines issued by the Centers for Disease Control (CDC) encourage the use of universal safety measures at all times when handing either biological or chemical specimens, or when in contact with patients, and has made latex work or examination gloves articles of standard practice, since they have contributed positively to reducing contamination.

Nonetheless, elastomeric articles, such as gloves, present unique microbial problems, the control of which can be complex. To control microorganism contamination on elastomeric surfaces in the past, traditional practice has been to employ disinfectants and/or sanitizers, such as, ammonia, chlorine, or alcohol. These techniques tend to work in the short-term but often do not have prolonged protective efficacy to contain or stop transmission of microbes on surfaces.

Gloves have been developed to limit the transfer of microbes from the glove surface to environmental surfaces. Commonly, the mechanism by which this is accomplished is to employ so-called leaching antimicrobial compositions on the glove surface. By this approach, the concentration of antimicrobial compositions on the glove surface gradually decrease as bacteria ingest the anti-microbial compounds, which proceed to kill them. Overtime, as its concentration is leached away, the effectiveness of the anti-microbial agent is reduced on the glove. Moreover, in recent years, concerns about biological resistance and the development of so-called “superbug” strains have prompted persons in the medical and health communities to be weary of using gloves with leaching antimicrobial compositions.

As alternative approach, researchers are turning toward ways to apply non-leaching antimicrobial compositions to the surfaces of gloves and other elastomeric articles. Producing elastomeric articles that have non-leaching antimicrobial agents immobilized on their surfaces generally not be very successful. An understanding of the surface chemistry and various other parameters is needed, and the effort or task of developing a process that can stably associate an antimicrobial to the surface of elastomeric articles has not been easy or trivial. Hence, a great need exists for one to develop a system or technique that can immobilize non-leaching antimicrobial compositions on an elastomeric substrate while maintaining a consistent and efficacious antimicrobial performance.

### SUMMARY OF THE INVENTION

In view of the present need for elastomeric articles that have stably associated non-leaching antimicrobial coatings, the present invention in-part relates to a method for preparing an elastomeric article having an antimicrobial coating on at least a portion of an outer surface. The method includes providing a substrate or body made from either a natural or synthetic polymer latex, the substrate being distinguished to have a first and a second surfaces, preparing or providing an antimicrobial solution containing an anti-foaming agent that is heated to a temperature of about 40.5° C. or 43° C. (105° F. or 110° F.) to about 80° C. (180° F.), desirably about 48° C. or 50-75° C., or more desirably about 55-72° C.; providing either a spray coating device having at least a nozzle atomizer or a bath of the antimicrobial solution; applying the heated antimicrobial solution either a) through the nozzle atomizer at a delivery air pressure of about 30-50 psi (206.84 kPa-344.74 kPa) and liquid flow of about 1.25 to 5.5 psi (8.62 kPa-37.92 kPa) to the first surface of the substrate while the substrate is tumbled in a heated rotary chamber, or by means of b) immersing in a heated bath, which is agitated or tumbled. In each iteration, either spraying or bath coating, the elastomeric articles are treated for an effective amount of time to substantively bind the antimicrobial coating to the substrate. An effective amount of time, as demonstrated herein, refers to a sufficient interval that will generate a durable and non-leaching attachment or bonding of the antimicrobial molecules to the surface of the elastomeric article. The duration may range from a few minutes (e.g., 5-30 minutes) to about 1-2 hours, depending on particular conditions.

The present invention, in another aspect, also relates an elastomeric article or product made according to the described method. The elastomeric article comprises a first surface having a stably associated, non-leaching antimicrobial coating over at least a portion of the first surface. The antimicrobial coating experience no leaching or loss of the antimicrobial molecules from the coated first surface when subject to a testing regime involving a first version or a second version, or both versions of a zone of inhibition test. That is, the elastomeric article generates no zones of inhibition when subject to a first and second versions of a zone of inhibition test.

According to the first version, referred to herein as a dry-leaching test, according to a protocol established by the American Association of Textile Chemists and Colorists (AATCC), a known concentration of microorganisms on the surface of an agar plate manifests no inhibition of growth or existence when a piece of an antimicrobial-treated substrate is placed on the agar plate and incubated. The absence of zones of inhibition indicates that no antimicrobial agent leaches or becomes unbound from the surface of the treated substrate. According the second version, referred to as the wet-leaching or dynamic shake flask test, according to a protocol established by the American Society for Testing and Materials (ASTM), the supernatant of a solution in which a piece of an anti-microbial-treated substrate has been incubated, is applied to an agar plate having a known amount of microbes on the plate surface, and the agar plate exhibits no zones of inhibition; hence, signifying that the antimicrobial agent bound to the treated substrate is substantively attached to the substrate, and has not leached into the supernatant solution.

Elastomeric articles coated with the non-fugative antimicrobial layer can demonstrate a level of biocide efficacy that produces a reduction in the concentration of microbes on the first surface by a magnitude of at least log₁₀ 1, when subject to a contact-transfer test protocol.

Additional features and advantages of the present protective elastomeric articles and associated methods of manufacture will be disclosed in the following detailed description. It is understood that both the foregoing summary and the following detailed description and examples are merely representative of the invention, and are intended to provide an overview for understanding the invention as claimed.

### BRIEF DESCRIPTION OF FIGURES

FIG. 1 depicts an elastomeric article, namely a glove 10, that one may prepare according to the present invention, having a substrate surface 12, with an stably associated, non-fugitive antimicrobial coating 14.

### DETAILED DESCRIPTION OF THE INVENTION

### Section 1—Definitions

In this specification and the appended claims, the singular forms “a,” “an,” and “the” include plural reference unless the context clearly dictates otherwise. Unless defined otherwise, all technical and scientific terms used herein have the same meaning as commonly understood or generally accepted by one of ordinary skill in the art to which this invention pertains.

As used herein, “antimicrobial” refers to the property of a compound, product, composition or article that enables it to prevent or reduce the growth, spread, propagation, or other life activities of a microbe or microbial culture.

As used herein, “antimicrobial polymer layer” refers to a coating, film or treatment formed using an antimicrobial composition or agent, as defined and described herein.

As used herein, “elastic” or elastomeric refers to the property of a material to be both stretchable by at least 10% (i.e., the material can expand to at least 110% original dimensions), and is able to contract and return to near net or original dimensions.

As used herein, “microbe” or “microorganism” refers to any organism or combination of organisms likely to cause infection or pathogenesis, for instance, bacteria, viruses, protozoa, yeasts, fungi, or molds.

As used herein, “non-leaching” or “non-fugitive” refers to the property of a material to be substantively attached to a substrate surface to which the material is applied, and renders the material unlikely to or incapable of spontaneously migrating, flaking, fragmenting, or being removed or stripped from the surface. A non-leaching antimicrobial coating can be further defined in reference to certain agar-plate-based contact and dynamic shake flask tests as specified in the AATCC-147 test protocol or ASTM E-2149-01 test protocol, in which the antimicrobial coated substrate generates no zones of inhibition, which indicate that no antimicrobial agent has detached from the substrate to inhibit microbial activity or growth. A “substantive coating” refers to a non-fugative coating, that is the coating is substantially attached to the surface of the elastomeric article.

### Section II—Description

The present invention generally relates to elastomeric substrates or articles can have reduced microbe affinity and transmission. The articles may take the form of gloves for either work, laboratory, examination, or medical and surgical uses, or catheters, balloons, condoms, or a mat or sheet. The elastomeric articles can be used to address, for instance, nosocomial, or hospital-acquired, infections that occur in thousands of patients each year. Although use of aseptic techniques may reduce the incidence of these infections, a significant risk remains. In recent years, the need for improvement in the quality of patient care has received increasing attention, particularly infection control. Disposable elastomeric articles, such as gloves, that reduces the potential for transmission between inanimate objects and the patient, or the health care worker and the patient, i.e., contact transfer, may significantly reduce the likelihood of the patient contracting a hospital-acquired infection. This reduction in infection rates may reduce the amount of antibiotics used, therefore reducing the rate at which microbes become antimicrobial resistant. Additional benefits of reduced infection rates may include reduction in patient length of hospital stay, reduction in health care costs associated with hospital-acquired infections, and reduction in danger of infection to health care workers. As such, given that no medical gloves having a non-fugitive or non-leaching antimicrobial coating are currently on the market, a need exists for disposable elastomeric gloves and other articles that features a mechanism for reducing microbe affinity and transmission. There is also a need for a method of making such a an article, and a method for determining the efficacy of such an article.

The elastomeric articles have a stably-associated antimicrobial coating that affords antimicrobial characteristics both during use and after disposal. The elastomeric article comprises an elastomeric substrate having a first surface, and an antimicrobial composition bound to said first surface forming a substantive or non-fugitive antimicrobial coating over at least a portion of the first surface, in a manner such that when the antimicrobial coating is subject to a either a) a first version involving a dry-leaching or agar-plate-based test, according to AATCC 147 protocol, or b) a second version involving a wet-leaching or dynamic shake flask test according to ASTM E-2149-01 protocol, or c) both versions of a zone of inhibition test, the antimicrobial coating produces no zones of inhibition. The substrate can be further subject to a contact-transfer test of relatively short duration, such as less than about 6 minutes, which exhibits a level of biocide efficacy that produces a reduction in the concentration of microbes that may be transferred onto said first surface by a magnitude of at least log₁₀ 1. Desirably, the substantive antimicrobial coatings can reduce microbe concentrations on the first surface by a magnitude of at least log₁₀ 3, or log₁₀ 4 or greater.

In another aspect, the present invention describes a method for irreversibly applying an antimicrobial compound to the external surface of an elastomeric article or substrate. Various types of antimicrobial compounds or polymers may be used according to the invention, so long as the antimicrobial agent is capable of binding or complexing with the elastomeric substrate surface. The antimicrobial coating may a combination of different biocides, each of which may be targeted to a particular kind of microbe species. These biocides that make up the substantive antimicrobial coating may be selected from at least one of the following: a quaternary ammonium compound, a polyquaternary amine, halogens, a halogen-containing polymer, a bromo-compound, a chlorine dioxide, a chlorhexidine, a thiazole, a thiocynate, an isothiazolin, a cyanobutane, a dithiocarbamate, a thione, a triclosan, an alkylsulfosuccinate, an alkyl-amino-alkyl glycine, a biguanides, a dialkyl-dimethyl-phosphonium salt, a cetrimide, hydrogen peroxide, 1-alkyl-1,5-diazapentane, or cetyl pyridinium chloride. Of these species, desirably, the antimicrobial is a cationic polymer such as polyhexamethylene biguanide (PHMB), chlorohexidine, polyquaternary amines, alkyl-amino-akyl glycines, 1-alkyl-1,5-diazapentane, dialkyl-dimethyl-phosphonium salts, cetrimide.

The substrate may be selected from a variety of elastomeric materials. For instance, the substrate can be natural rubber and/or synthetic polymer lattices, such as nitrile rubber, vinyl, styrene-ethylene-butylene-styrene (SEBS), or styrene-butadiene-styrene (SBS) copolymer materials.

The method or treatment technique for generating a substantive or non-fugitive antimicrobial coating on a surface of an elastomeric substrate involves associating antimicrobial agents with a substrate having either a polar surface or a reactive surface. The antimicrobial coatings is prepared and applied to the elastomeric substrate on at least a first surface according to a heat-activated treatment. The treatment may be practiced by means of either a spray-on technique or dipping a formed article in an immersion bath of antimicrobial solution.

In the spray treatment technique, desirably, an aerosol delivery air system is used during or following the chlorination process. The aerosol delivery air pressure is about 40 psi and the liquid flow rate of the solution is about 2-4.75 or 5 psi, preferably about 3-4 psi. The rotary chamber can be a drum, such as in a washing machine, and is heated to a temperature of about 60° C. (˜140° F.) to about 82.2° C. (˜180° F.), preferably about 64° C. (˜147° F.) or 71° C. (˜160° F.) to about 75° C. In the bath, the solution can be heated to a temperature of about 40.5° C. (105° F.) or 43.3° C. (110° F.) to about 75° C. (˜167° F.), preferably about 46° C. (˜115° F.) to about 63° C. (˜145° F.) or 65.5° C. (150° F.), more desirably about 48-55° C. (˜120-133° F.). As actual temperature conditions change according to specific parameters, persons skilled in the art understand that the effective times over which one applies the antimicrobial treatment will also change accordingly. As envisioned herein, effective times can be as short as 8 or 9 minutes, but are desirably are at least about 12 minutes, more desirably about 15 to 20 or 30 minutes. Longer durations of about 40, 45, or 60 minutes also can be used. It appears that, the longer the duration that the articles are in contact with the antimicrobial solution under the heated conditions, the greater the durability and stability of the antimicrobial coating remains on the surface of the treated article. The antimicrobial coatings can be characterized to the extent that the antimicrobial coating is bound and can pass either the first or second, or both versions of the zone of inhibition test described herein. Wherein, the first version involves a dry-leaching test protocol, and the second version involves a wet-leaching test protocol.

Although not to be bound to any particular theory, it is believed that either the heating of the antimicrobial solution or the heat treatment application, or a combination of both can promote a more efficient binding of said antimicrobial agent with said substrate. Application of the antimicrobial agents under hot conditions (e.g., ≧about 100° F. (˜37.8° C.)) helps, in part, with orienting the antimicrobial molecules on the surface of the elastomeric substrate and creating a more efficient cross-linkage of the antimicrobial agents with each other and/or with the coated surface, which helps hinder leaching. Whereas before a great amount of antimicrobial compound was needed to properly and completely coat the outer surface of a glove, faster orientation of the molecules, it is believed, permits coating with a lesser amount of antimicrobial compounds for coating the elastomeric substrate to achieve the same results, if not a simultaneous surprising increase in the efficacy of kills after undergoing the heated application treatment. Hence, this savings in the amount of antimicrobial material actually allows one to achieve greater coats savings for the same amount of material. For instance, the concentration of antimicrobial agent added on to the surface of the elastomeric substrate could be reduced even lower then about 0.005 g/glove. With atomized spraying techniques, a temperature higher that that used for immersion bath techniques is required to maintain the temperature of the antimicrobial solution in air. However, the degree of benefit or effective enhancement to substantive attachment of the antimicrobial coating to the substrate surface seems to level off with ever increasing temperatures. Hence, a preferred range of temperatures is from about 105° F. (40.5° C.) to about 185° F. (85° C.), depending on the particular application technique used.

Another beneficial aspect of a glove or other article of the present invention is that elastomeric substrates and articles subject to the present treatment can have durable antimicrobial characteristics. The antimicrobial coating formed on the surface of the glove is non-leaching in the presence of aqueous substances, strong acids and bases, and organic solvents. Because the antimicrobial agents are bound to the surface of the glove, the antimicrobial effect seems to be chemically more durable, hence providing an antimicrobial benefit for a longer duration.

Further, the non-fugative nature of the antimicrobial coating can minimize microbial transmission and the development of resistant strains of so-called “super-bugs.” Traditional agents leach from the surface of the article, such as the glove, and must be consumed by the microbe to be effective. When such traditional agents are used, the microbe is poisoned and destroyed only if the dosing is lethal. If the dosing is sublethal, the microbe may adapt and become resistant to the agent. As a result, hospitals are reluctant to introduce such agents into the sterile environment. Furthermore, because these antimicrobial agents are consumed in the process, the efficacy of the antimicrobial treatment decreases with use. The antimicrobial compounds or polymers used with the present invention are not consumed by the microbes. Rather, the antimicrobial agents rupture the membrane of microbes that are present on the glove surface.

The presence of the antimicrobial coating and its even distribution over the surface of the coated article can be monitored or determined using an indicator dye, such as tetrabromofluorescein (Eosin Yellowish),

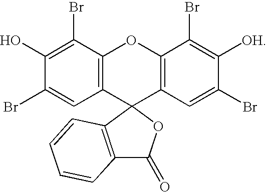

When this dye is applied to an antimicrobial-treated surface, the surface turns a reddish color only with the presence of a positively charged antimicrobial coating, such as PHMB. The dye is negatively charged, hence it will bind with the cationic antimicrobial molecules on the surface.

In gloves or other articles that a consumer may put on his or her body, the antimicrobial agents are desirably kept on the first or exterior surface, away from a wearer's skin, which contacts the second or interior surface of the article. Desirably, the glove can have a textured surface. A key benefit to using a textured surface versus a non-textured surface is that a textured surface has less contact points when touching a contaminated object that it allows for fewer organisms to be picked up by the gloves surface, hence reducing the likelihood of contact transfer of microorganisms from the surface of the article to the glove.

### A

An elastomeric article, for example a glove, to be treated according to the present invention may be first formed using a variety of processes that may involve dipping, spraying, tumbling, drying, and curing steps. To illustrate an example of a dipping process for forming a glove is described herein, though other processes may be employed to form various articles having different shapes and characteristics. For example, a condom may be formed in substantially the same manner, although some process conditions may differ from those used to form a glove. Although a batch process is described and shown herein, it should be understood that semi-batch and continuous processes may also be utilized with the present invention.

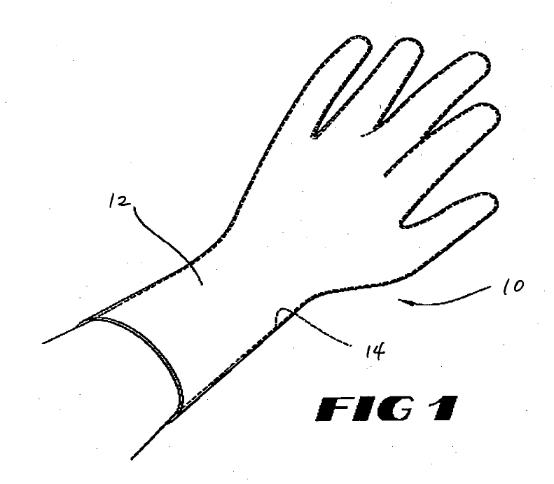

A glove 10, like in FIG. 1, can be formed on a hand-shaped mold called a “former.” The former may be made from any suitable material, such as glass, metal, porcelain, or the like. The surface of the former may textured or smooth, and defines at least a portion of the surface of the glove to be manufactured. The glove includes an exterior surface and an interior surface. The interior surface is generally the wearer-contacting surface.

The former is conveyed through a preheated oven to evaporate any water present. The former may then dipped into a bath typically containing a coagulant, a powder source, a surfactant, and water. The coagulant may contain calcium ions (from e.g., calcium nitrate) that enable a polymer latex to deposit onto the former. The powder may be calcium carbonate powder, which aids release of the completed glove from the former. The surfactant provides enhanced wetting to avoid forming a meniscus and trapping air between the form and deposited latex, particularly in the cuff area. However, any suitable coagulant composition may be used, including those described in U.S. Pat. No. 4,310,928 to Joung, incorporated herein in its entirety by reference. The residual heat evaporates the water in the coagulant mixture leaving, for example, calcium nitrate, calcium carbonate powder, and the surfactant on the surface of the former. Although a coagulant process is described herein, it should be understood that other processes may be used to form the article of the present invention that do not require a coagulant. For instance, in some embodiments, a solvent-based process may be used.

The coated former is then dipped into a polymer bath, which is generally a natural rubber latex or a synthetic polymer latex. The polymer present in the bath includes an elastomeric material that forms the body of the glove. In some embodiments, the elastomeric material, or elastomer, includes natural rubber, which may be supplied as a compounded natural rubber latex. Thus, the bath may contain, for example, compounded natural rubber latex, stabilizers, antioxidants, curing activators, organic accelerators, vulcanizers, and the like. In other embodiments, the elastomeric material may be nitrile butadiene rubber, and in particular, carboxylated nitrile butadiene rubber. In other embodiments, the elastomeric material may be a styrene-ethylene-butylene-styrene block copolymer, styrene-isoprene-styrene block copolymer, styrene-butadiene-styrene block copolymer, styrene-isoprene block copolymer, styrene-butadiene block copolymer, synthetic isoprene, chloroprene rubber, polyvinyl chloride, silicone rubber, polyurethane, or a combination thereof.

The stabilizers may include phosphate-type surfactants. The antioxidants may be phenolic, for example, 2,2′-methylenebis (4-methyl-6-t-butylphenol). The curing activator may be zinc oxide. The organic accelerator may be dithiocarbamate. The vulcanizer may be sulfur or a sulfur-containing compound. To avoid crumb formation, the stabilizer, antioxidant, activator, accelerator, and vulcanizer may first be dispersed into water by using a ball mill and then combined with the polymer latex.

During the dipping process, the coagulant on the former causes some of the elastomer to become locally unstable and coagulate onto the surface of the former. The elastomer coalesces, capturing the particles present in the coagulant composition at the surface of the coagulating elastomer. The former is withdrawn from the bath and the coagulated layer is permitted to fully coalesce, thereby forming the glove. The former is dipped into one or more baths a sufficient number of times to attain the desired glove thickness. In some embodiments, the glove may have a thickness of from about 0.004 inches (0.102 mm) to about 0.012 inches (0.305 mm).

The former may then be dipped into a leaching tank in which hot water is circulated to remove the water-soluble components, such as residual calcium nitrates and proteins contained in the natural rubber latex and excess process chemicals from the synthetic polymer latex. This leaching process may generally continue for about 12 minutes at a water temperature of about 120° F. The glove is then dried on the former to solidify and stabilize the glove. It should be understood that various conditions, processes, and materials used to form the glove. Other layers may be formed by including additional dipping processes. Such layers may be used to incorporate additional features into the glove.

The glove is then sent to a curing station where the elastomer is vulcanized, typically in an oven. The curing station initially evaporates any remaining water in the coating on the former and then proceeds to a higher temperature vulcanization. The drying may occur at a temperature of from about 85° C. to about 95° C., and the vulcanizing may occur at a temperature of from about 110° C. to about 120° C. For example, the glove may be vulcanized in a single oven at a temperature of 115° C. for about 20 minutes. Alternatively, the oven may be divided into four different zones with a former being conveyed through zones of increasing temperature. For instance, the oven may have four zones with the first two zones being dedicated to drying and the second two zones being primarily for vulcanizing. Each of the zones may have a slightly higher temperature, for example, the first zone at about 80° C., the second zone at about 95° C., a third zone at about 105° C., and a final zone at about 115° C. The residence time of the former within each zone may be about ten minutes. The accelerator and vulcanizer contained in the latex coating on the former are used to crosslink the elastomer. The vulcanizer forms sulfur bridges between different elastomer segments and the accelerator is used to promote rapid sulfur bridge formation.

Upon being cured, the former may be transferred to a stripping station where the glove is removed from the former. The stripping station may involve automatic or manual removal of the glove from the former. For example, in one embodiment, the glove is manually removed and turned inside out as it is stripped from the former. By inverting the glove in this manner, the exterior of the glove on the former becomes the inside surface of the glove. It should be understood that any method of removing the glove from the former may be used, including a direct air removal process that does not result in inversion of the glove.

The solidified glove, or a plurality of solidified gloves, may then subjected to various post-formation processes, including application of one or more treatments to at least one surface of the glove. For instance, the glove may be halogenated to decrease tackiness of the interior surface. The halogenation (e.g., chlorination) may be performed in any suitable manner, including: (1) direct injection of chlorine gas into a water mixture, (2) mixing high density bleaching powder and aluminum chloride in water, (3) brine electrolysis to produce chlorinated water, and (4) acidified bleach. Examples of such methods are described in U.S. Pat. No. 3,411,982 to Kavalir; U.S. Pat. No. 3,740,262 to Agostinelli; U.S. Pat. No. 3,992,221 to Homsy, et al.; U.S. Pat. No. 4,597,108 to Momose; and U.S. Pat. No. 4,851,266 to Momose, U.S. Pat. No. 5,792,531 to Littleton, et al., which are each herein incorporated by reference in their entirety. In one embodiment, for example, chlorine gas is injected into a water stream and then fed into a chlorinator (a closed vessel) containing the glove. The concentration of chlorine may be altered to control the degree of chlorination. The chlorine concentration may typically be at least about 100 parts per million (ppm). In some embodiments, the chlorine concentration may be from about 200 ppm to about 3500 ppm. In other embodiments, the chlorine concentration may be from about 300 ppm to about 600 ppm. In yet other embodiments, the chlorine concentration may be about 400 ppm. The duration of the chlorination step may also be controlled to vary the degree of chlorination and may range, for example, from about 1 to about 10 minutes. In some embodiments, the duration of chlorination may be about 4 minutes.

Still within the chlorinator, the chlorinated glove or gloves may then be rinsed with tap water at about room temperature. This rinse cycle may be repeated as necessary. The gloves may then be tumbled to drain the excess water. At this point of the manufacturing process, one can repeated the rinse, and executed the present inventive antimicrobial application treatment under heated conditions.

A lubricant composition may then be added into the chlorinator, followed by a tumbling process that lasts for about five minutes. The lubricant forms a layer on at least a portion of the interior surface to further enhance donning of the glove. In one embodiment, this lubricant may contain a silicone or silicone-based component. As used herein, the term “silicone” generally refers to a broad family of synthetic polymers that have a repeating silicon-oxygen backbone, including, but not limited to, polydimethylsiloxane and polysiloxanes having hydrogen-bonding functional groups selected from the group consisting of amino, carboxyl, hydroxyl, ether, polyether, aldehyde, ketone, amide, ester, and thiol groups. In some embodiments, polydimethylsiloxane and/or modified polysiloxanes may be used as the silicone component in accordance with the present invention. For instance, some suitable modified polysiloxanes that may be used in the present invention include, but are not limited to, phenyl-modified polysiloxanes, vinyl-modified polysiloxanes, methyl-modified polysiloxanes, fluoro-modified polysiloxanes, alkyl-modified polysiloxanes, alkoxy-modified polysiloxanes, amino-modified polysiloxanes, and combinations thereof. Examples of commercially available silicones that may be used with the present invention include DC 365 available from Dow Corning Corporation (Midland, Mich.), and SM 2140 available from GE Silicones (Waterford, N.Y.). However, it should be understood that any silicone that provides a lubricating effect may be used to enhance the donning characteristics of the glove. The lubricant solution is then drained from the chlorinator and may be reused if desired. It should be understood that the lubricant composition may be applied at a later stage in the forming process, and may be applied using any technique, such as dipping, spraying, immersion, printing, tumbling, or the like.

After the various processes described above, the glove may be inverted (if needed) to expose the exterior surface of the elastomeric article, for example, the glove. Any treatment, or combination of treatments, may then be applied to the exterior surface of the glove. Individual gloves may be treated or a plurality of gloves may be treated simultaneously. Likewise, any treatment, or combination of treatments, may be applied to the interior surface of the glove. Any suitable treatment technique may be used, including for example, dipping, spraying, immersion, printing, tumbling, or the like.

The coated glove may then put into a tumbling apparatus or other dryer and dried for about 10 to about 60 minutes (e.g., 40 minutes) at from about 20° C. to about 80° C. (e.g., 40° C.). The glove may then be inverted to expose the exterior surface, which may then be dried for about 20 to about 100 minutes (e.g., 60 minutes) at from about 20° C. to about 80° C. (e.g., 40° C.). Alternatively during this step of the manufacturing process one can execute the present inventive antimicrobial treatment application. In this way the antimicrobial treatment can be integrated into the online manufacturing process.

To apply the antimicrobial compositions to the gloves, a plurality of gloves may be placed in a closed vessel, where the gloves are immersed in an aqueous solution of the antimicrobial composition. In some embodiments, the antimicrobial composition may be added to water so that the resulting treatment includes about 0.05 mass % to about 10 mass % solids. In other embodiments, the antimicrobial composition may be added to water so that the resulting treatment includes from about 0.5 mass % to about 7 mass % solids. In other embodiments, the antimicrobial composition may be added to water so that the resulting treatment includes from about 2 mass % to about 6 mass % solids. In still another embodiment, the antimicrobial composition may be added to water so that the resulting treatment includes about 3 mass % solids. The gloves may be agitated if desired. The duration of the immersion may be controlled to vary the degree of treatment and may range, for example, from about 1 to about 10 minutes. For instance, the gloves may be immersed for about 6 minutes. The gloves may be immersed multiple times as needed to achieved the desired treatment level. For instance, the glove may undergo 2 immersion cycles.

The gloves may then be rinsed as needed to remove any excess antimicrobial composition. The gloves may be rinsed in tap water and/or deionized water as desired. After the gloves have been sufficiently rinsed, the excess water is extracted from the vessel and the gloves may be transferred to a tumbling apparatus or other dryer. The gloves may be dried for about 10 to about 60 minutes at from about 20° C. to about 80° C. For instance, the exterior surface of the gloves may be dried for about 40 minutes at a temperature of about 65° C. The gloves may then be inverted to expose the interior surface, which may then be dried for about 10 to about 60 minutes (e.g., 40 minutes) at from about 20° C. to about 80° C. For instance, the interior surface of the gloves may be dried for about 40 minutes at a temperature of about 40° C.

The antimicrobial polymer may be formed on the gloves to any extent suitable for a given application. The amount of polymer formed on the glove may be adjusted to obtain the desired reduction in microbe affinity, resistance to growth, and resistance to contact transfer, and such amount needed may vary depending on the microbes likely to be encountered and the application for which the article may be used. In some embodiments, the composition may be applied to the glove so that the resulting antimicrobial polymer is present in an amount of from about 0.05 mass % to about 10 mass % of the resulting glove. In other embodiments, the resulting antimicrobial polymer may be present in an amount of from about 1 mass % to about 7 mass % of the resulting glove. In yet other embodiments, the resulting antimicrobial polymer may be present in an amount of from about 2 mass % to about 5 mass % of the resulting glove.

### B

Manufacturing an elastomeric having durable, non-fugitive antimicrobial coating on substrate is not trivial in that it is often difficult to create a antimicrobial layer that is both stably associated to the surface and exhibits a satisfactory level of effective microbicide functionality. The antimicrobial activity of a biocide is highly dependent on several factors. The most important of which are time of exposure, concentration, temperature, pH, and the presence of ions and organic mater. To add to this complexity, the efficacy of surface bound antimicrobials is directly influenced by the ability of that molecule to be bioavailability. This requires the active molecule to be oriented on the material surface such that it can directly interact with the cell.

In part, the present invention builds upon research that was described in U.S. Patent Application Publication No. 2004/0151919, the content of which is incorporated herein by reference. In that application, we describe the use and immobilization of a silane ammonium quaternary compounds, or organosilane composition, in a suitable solvent, that is effective when externally bound to a glove. In particular, we discussed the use of various combinations of 3-(trimethoxysilyl) propyldimethyloctadecyl ammonium chloride in methanol in the Microbeshield® product line, commercially available from Aegis Environments in Midland, Mich. For example, according to product literature, AEM 5700 is 43% 3-(trimethoxysilyl) propyldimethyloctadecyl ammonium chloride in methanol (with small percentages of other inactives) and AEM 5772 is 72% 3-(trimethoxysilyl) propyldimethyloctadecyl ammonium chloride in methanol (with small percentages of other inactives).

In further investigations, the lack of performance of AEM 5700 as a surface active antimicrobial on medical or healthcare gloves has pointed to the probable miss-orientation of that molecule on the surface of the glove imparting poor efficacy as determined by the required evaluation methods. One approach to overcome this limitation is to alter the surface of the glove before addition of the biocide. An alternative approach is to employ another active that has fewer limitations for this application. To this end an alternative surface biocide, polyhexamethylene biguanide, was suggested. This active has been shown to be retained on surfaces, provide a fast kill time, and is reported to be broad spectrum in efficacy. The results of our experimental trials are summarized in Section III—Empiricals.

The biguanide group is a very alkaline species, which remains in the cationic (protonated) form up to about pH 10 and interacts strongly and very rapidly with anionic species. Polyhexamethylene biguanide (PHMB) has highly basic biguanide groups linked with hexamethylene spacers to give a polymer with an average of 12 repeat units. The mechanism of PHMB action in bacteria and fungi is the disruption of the outer cellular membranes by means of 1) displacing divalent cations that provide structural integrity and 2) binding to membrane phospholipids. These actions provide disorganization of the membrane and subsequent shutting down of all metabolic process that rely on the membrane structure such as energy generation, proton motive force, as well as transporters. PHMB is particularly effective against pseudomonads. There is a substantial amount of microbiological evidence that disruption of the cellular membrane is a lethal event. Once the outer membrane has been opened up, PHMB molecules can access the cytoplasmic membrane where they bind to negatively charged phospholipids.

There is a substantial amount of microbiological and chemical evidence that disruption of the cytoplasmic membrane is the lethal event. This can be modeled in the laboratory by producing small unilamellar phospholipid vesicles (50-100 nm in diameter) that are loaded with a dye. Addition of PHMB in the physiological concentration range causes rapid disruption of the vesicles (observed by monitoring release of the dye) and the time constant for the reaction corresponds to the rapid rate of kill.

Studies with artificial multilamellar vesicles made from different lipids have shown that PHMB binds strongly to anionic or non-ionic membranes. The very strong affinity of PHMB for negatively charged molecules means that it can interact with some common anionic (but not cationic or nonionic) surfactants used in coatings formulations. However, it is compatible with polyvinyl alcohol, cellulosic thickeners and starch-based products and works well in polyvinyl acetate and vinyl acetate-ethylene emulsion systems. It also gives good performance in silicone emulsions and cationic electrocoat systems. Simple compatibility tests quickly show if PHMB is compatible with a given formulation and stable systems can often be developed by fine-tuning anionic components.

The PHMB molecule may bind to the glove through complex charge interaction associating with the regions of the glove that have negative charge. Once the bacteria comes within close proximity of the PHMB molecule the PHMB is transferred to the much more highly negatively charged bacterial cell. Alternatively, the hydrophobic regions of the biguanide may interactive with the hydrophobic regions of the glove allowing the charge regions of the PHMB molecule accessibility to interact with the bacteria and penetrate the membrane. The true mechanism is likely a mixture of both types of interactions. Although, the particular mechanism of retention to the glove is not well understood at present, our most recent leaching data implies it does indeed stick to the glove and not does not leach as defined by ASTM testing methods, described in the empirical section, below.

### Section III—Empirical

The gloves were either sprayed with a heated solution or immersed in a heated bath containing an antifoaming agent, a quaternary ammonium compound, and cetyl pyridinium chloride. An alternative antimicrobial agent was also tried polyhexamethylene biguanide (PHMB). The solution is heated by the spray atomizer or in a heated canister before entering the atomizer while tumbling in a forced air-dryer. This method allows only the outside of the glove to be treated more efficiently with less solution and still provide the antimicrobial efficacy desired, better adhesion of the antimicrobial to mitigate any leaching of the agent off the surface, and also eliminates the potential for skin irritation for the wearer due to constant contact between the biocide and the healthcare worker's skin. The immersion-coated gloves remain closed so that any antimicrobial coating that happened to find its way to the interior of the glove remained near the cuff opening, without affecting the further inner surfaces of the glove. The external glove surface was investigated. Textured formers were used as well as non-textured to evaluate surface area in contact with the microorganisms.

### A

To assess whether the applied antimicrobial coating on the elastomeric materials truly are stable and do not leach from the substrate surface, two tests are employed. First, according to the American Association of Textile Chemists and Colorists (AATCC)-147 test protocol, in a dry-leaching test, we prepared a sample of antimicrobial-treated glove material and placed it in an agar plate seeded with a known amount of organism population on the plate surface. The plate was incubated for about 18-24 hours at about 35° C. or 37° C.±2° C. Afterwards, the agar plate is assessed. Any leaching of the antimicrobial from the glove material would result in a zone of inhibited microbial growth. As Table 1A summarizes the results for several samples tested, we found no zones of inhibition, indicating that no antimicrobial agent leached from any of the glove samples.

Second, in a wet-leaching zone of inhibition test, according to the American Society for Testing and Materials (ASTM) E 2149-01 test protocol involving a dynamic shake flask, we placed several pieces of an antimicrobial-coated glove in a 0.3 mM solution of phosphate (KH₂PO₄) at buffer pH ˜6.8. The piece of glove was let to sit for 24 hours in solution and then the supernatant of the solution was extracted. The extraction conditions involved where about 30 minutes at room temp (˜23° C.) with 50 ml of buffer in a 250 ml Erlenmeyer flask. The flask is shaken in a wrist shaker for 1 hour±5 minutes. About 100 micro liters (μL) of supernatant is added to a 8 mm well cut into a seeded agar plate and allow to dry. After about 24 hours at 35° C.±2° C., the agar plate is examined for any indicia of inhibition of microbial activity or growth. The absence of any zones of inhibition, as summarized in Table 1B, suggests no leaching of the antimicrobial from the surface of the glove into the supernatant, or its effect on the microorganism on the agar plate. The data presented in Tables 1A and 1B are the results from when the antimicrobial coating is applied in a washing machine.

To further elaborate the zone of inhibition test and contact-transfer test protocols, a desired inoculum may then be placed aseptically onto a first surface. Any quantity of the desired inoculum may be used, and in some embodiments, a quantity of about 1 ml is applied to the first surface. Furthermore, the inoculum may be applied to the first surface over any desired area. In some instances, the inoculum may be applied over an area of about 7 inches (178 mm) by 7 inches (178 mm). The first surface may be made of any material capable of being sterilized. In some embodiments, the first surface may be made of stainless steel, glass, porcelain, a ceramic, synthetic or natural skin, such as pig skin, or the like.

The inoculum may then be permitted to remain on the first surface for a relatively short amount of time, for example, about 2 or 3 minutes before the article to be evaluated, i.e., the transfer substrate, is brought into contact with the first surface. The transfer substrate may be any type of article. Particular applicability may be, in some instances, for examination or surgical gloves. The transfer substrate, for example, the glove, should be handled aseptically. Where the transfer substrate is a glove, a glove may be placed on the left and right hands of the experimenter. One glove may then be brought into contact with the inoculated first surface, ensuring that the contact is firm and direct to minimize error. The test glove may then be immediately removed using the other hand and placed into a flask containing a desired amount of sterile buffered water (prepared above) to extract the transferred microbes. In some instances, the glove may be placed into a flask containing about 100 ml of sterile buffered water and tested within a specified amount of time. Alternatively, the glove may be placed into a flask containing a suitable amount of Letheen Agar Base (available from Alpha Biosciences, Inc. of Baltimore, Md.) to neutralize the antimicrobial treatment for later evaluation. The flask containing the glove may then be placed on a reciprocating shaker and agitated at a rate of from about 190 cycles/min. to about 200 cycles/min. The flask may be shaken for any desired time, and in some instances is shaken for about 2 minutes.

The glove may then be removed from the flask, and the solution diluted as desired. A desired amount of the solution may then be placed on at least one agar sample plate. In some instances, about 0.1 ml of the solution may be placed on each sample plate. The solution on the sample plates may then be incubated for a desired amount of time to permit the microbes to propagate. In some instances, the solution may incubate for at least about 48 hours. The incubation may take place at any optimal temperature to permit microbe growth, and in some instances may take place at from about 33° C. to about 37° C. In some instances, the incubation may take place at about 35° C.

After incubation is complete, the microbes present are counted and the results are reported as CFU/ml. The percent recovery may then be calculated by dividing the extracted microbes in CFU/ml by the number present in the inoculum in (CFU/ml), and multiplying the value by 100.

In another aspect, to assess the efficacy of how rapidly the applied antimicrobial agents kill, we employed a direct contact, rapid germicidal test, developed by Kimberly-Clark Corporation. This test better simulates real world working situations in which microbes are transferred from a substrate to glove through direct contacts of short duration. Also this test permits us to assess whether contact with the surface of the glove at one position will quickly kill microbes, whereas the solution-based testing of the ASTM E 2149-01 protocol tends to provide multiple opportunities to contact and kill the microbes, which less realistic in practice.

We applied an inoculum of a known amount of microbes to the antimicrobial-treated surface of a glove. After about 3-6 minutes, we assessed the number of microbes that remained on the surface of the treated glove. Any sample with a logarithmic (log₁₀) reduction of about 0.8 or greater is effective and exhibits a satisfactory performance level. As with contact transfer tests performed according to current ASTM protocols, a reduction in the concentration of microbes on the order magnitude of about log₁₀ 1, is efficacious. Desirably, the level of microbial concentration can be reduced to a magnitude of about log₁₀ 3, or more desirably about log₁₀ 4 or greater. Table 2 reports the relative efficacy of killing after contact with the coated glove. The concentration of organisms on the surface is given at an initial Zero Time point and at 3, 5, and 30 minute points. As one can see, the resulting percentage reduction in the number of organisms at time zero and after 3, 5, and 30 minutes are dramatic. Significantly, within the first few minutes the contact with the antimicrobial kills virtually all (96-99% or greater) of the microorganisms present.

### B

To test the antimicrobial efficacy of a polyhexamethylene biguanide, such as available commercially under the trademark Cosmosil® CQ from Arch Chemicals, Inc., Norwalk, Conn., we treated nitrile examination gloves according to ASTM protocol 04-123409-106 “Rapid Germicidal Time Kill.” Briefly, about 50 μL of an overnight culture of Staphylococcus aureus (ATCC #27660, 5×10⁸CFU/mL) was applied to the glove material. After a total contact time of about 6 minutes the glove fabric was placed into a neutralizing buffer. Surviving organisms were extracted and diluted in Letheen broth. Aliquots were spread plated on Tryptic Soy Agar plates. Plates were incubated for 48 hours at 35° C. Following incubation the surviving organisms were counted and the colony forming units (CFU) were recorded. The reduction (log₁₀) in surviving organisms from test material versus control fabric was calculated:

Log₁₀ CFU/swatch Control−Log₁₀ CFU/swatch Test Article=Log₁₀ Reduction.

We found that on the microtextured nitrile glove samples evaluated, treatment with polyhexamethylene biguanide produced a greater than four log reduction of Staphylococcus aureus when machine applied at 0.03 g/glove. The results are summarized in Table 3, as follows.

TABLE 3

| | | | Log | |
|---|---|---|---|---|
| HT# | KC# | Antimicrobial Treatment* | Recovery | Result† |
| 167 | 45 | Microgrip Nitrile control | 3.72 | control |
| | | (RSR nitrile) 89-8 | | |
| 168 | 46 | PHMB^{a} Hot Spray | 5.88 | 1.32 |
| | | (0.03 g/glove) with Q2-5211 + 89-5 | | |
| 169 | 48 | PHMB^{a} Hot Spray | <2.38 | >4.7 |
| | | (0.03 g/glove) 89-7 | | |
| 161 | 39 | PFE control (testing reported | 7.23 | control |
| | | 9/15/2004) 87-1 | | |

The treatment of nitrile gloves with polyhexamethylene biguanide demonstrates a greater than one log reduction of organisms when hand sprayed with no heat and a greater than 5 log reduction when machine sprayed under heated conditions. The nitrile control material demonstrated inherent antimicrobial efficacy of three and four logs. These results are comparing the reduction in applied organisms (estimated from the latex control material Table 4).

TABLE 4
Latex Glove Samples Evaluated:

| Sample | | Log | |
|---|---|---|---|
| No. | Antimicrobial Treatment | Recovery | Result |
| 1 | PFE control | 7.23 | control |
| 2 | 0.03 g/glove PHMB^{a} machine sprayed | <1.4 | >5.83 |
| | (3 cycles; 600 glove lot w/1.5 L | | |
| | spray; pickup˜0.02 g/glove) | | |

TABLE 5
Nitrile Glove Samples Evaluated:

| Sample | | Log | |
|---|---|---|---|
| No. | Antimicrobial Treatment | Recovery | Result† |
| 1 | Nitrile control (RSR nitrile) | 3.08 | control |
| 2 | Hand sprayed PHMB^{a} 2% (ballpark | 5.95 | NR |
| | estimate of 0.03 g/glove); | | |
| | microgirp nitrile | | |
| 3 | Nitrile control (RSR nitrile) | 4.00 | control |
| 4 | PHMB^{a} machine sprayed ˜0.03 | <2.15 | >1.85 |
| | g/glove (160° F.; 1 cycle, 30 | | |
| | min, 1.5 L total spray, 600 | | |
| | glove batch) | | |

†No Reduction = less than 0.5 log reduction of test glove compared to control glove.
Inoculum: 8.08

Zone of inhibition testing was completed to evaluate adherence of the antimicrobial agent. The results are summarized below in Tables 6 and 7.

TABLE 6

| | | | Zone of | Test | Sample |
|---|---|---|---|---|---|
| Sample # | description | Inoculum Level | Inhibition | Organism | Size |
| 1 | Nitrile substrate | 1.1 × 10⁵ CFU/ml | none | S. aureus | 100 μl |
| 2 | Nitrile substrate | 1.1 × 10⁵ CFU/ml | none | S. aureus | 100 μl |
| 3 | Nitrile substrate | 1.1 × 10⁵ CFU/ml | none | S. aureus | 100 μl |
| 4 | Nitrile substrate | 1.1 × 10⁵ CFU/ml | none | S. aureus | 100 μl |
| 5 | Negative Control - Nitrile substrate | 1.1 × 10⁵ CFU/ml | none | S. aureus | 100 μl |
| 6 | Positive control - 0.5% Amphyl (v:v) | 1.1 × 10⁵ CFU/ml | 5 mm | S. aureus | 100 μl |

TABLE 7

| | | | Zone of | Test | Sample |
|---|---|---|---|---|---|
| Sample # | description | Inoculum Level | Inhibition | Organism | Size |
| 1 | Nature Rubber Latex substrate | 1.3 × 10⁵ CFU/ml | none | S. aureus | 100 μl |
| 2 | Nature Rubber Latex substrate | 1.3 × 10⁵ CFU/ml | none | S. aureus | 100 μl |
| 3 | Nature Rubber Latex substrate | 1.3 × 10⁵ CFU/ml | none | S. aureus | 100 μl |
| 4 | Nature Rubber Latex substrate | 1.3 × 10⁵ CFU/ml | none | S. aureus | 100 μl |
| 5 | Nature Rubber Latex substrate | 1.3 × 10⁵ CFU/ml | none | S. aureus | 100 μl |
| 6 | Negative Contol - Nature Rubber Latex substrate | 1.3 × 10⁵ CFU/ml | none | S. aureus | 100 μl |
| 7 | Positive Control - 0.5% Amphyl (v:v) | 1.3 × 10⁵ CFU/ml | 5 mm | S. aureus | 100 μl |

The present invention has been described in general and in detail by way of examples. The words used are words of description rather than of limitation. Persons of ordinary skill in the art understand that the invention is not limited necessarily to the embodiments specifically disclosed, but that modifications and variations may be made without departing from the scope of the invention as defined by the following claims or their equivalents, including other equivalent components presently known, or to be developed, which may be used within the scope of the present invention. Therefore, unless changes otherwise depart from the scope of the invention, the changes should be construed as being included herein and the appended claims should not be limited to the description of the preferred versions herein.

TABLE 1A
“Dry Leaching” AATCC 147-1988 Protocol as Modified

| Sample # | description | Inoculum Level | Zone of Inhibition | Test Organism | Sample Size |
|---|---|---|---|---|---|
| 1-1 | Nitrile Substrate | 1.6 × 10⁵ CFU/ml | none | S. aureus (ATCC #27660) | 8 mm |
| 1-2 | Nitrile Substrate | 1.6 × 10⁵ CFU/ml | none | S. aureus (ATCC #27660) | 8 mm |
| 1-3 | Nitrile Substrate | 1.6 × 10⁵ CFU/ml | none | S. aureus (ATCC #27660) | 8 mm |
| 2-1 | Nitrile Substrate | 1.6 × 10⁵ CFU/ml | none | S. aureus (ATCC #27660) | 8 mm |
| 2-2 | Nitrile Substrate | 1.6 × 10⁵ CFU/ml | none | S. aureus (ATCC #27660) | 8 mm |
| 2-3 | Nitrile Substrate | 1.6 × 10⁵ CFU/ml | none | S. aureus (ATCC #27660) | 8 mm |
| 3-1 | Nitrile Substrate | 1.6 × 10⁵ CFU/ml | none | S. aureus (ATCC #27660) | 8 mm |
| 3-2 | Nitrile Substrate | 1.6 × 10⁵ CFU/ml | none | S. aureus (ATCC #27660) | 8 mm |
| 3-3 | Nitrile Substrate | 1.6 × 10⁵ CFU/ml | none | S. aureus (ATCC #27660) | 8 mm |
| 4-1 | Nitrile Substrate | 1.6 × 10⁵ CFU/ml | none | S. aureus (ATCC #27660) | 8 mm |
| 4-2 | Nitrile Substrate | 1.6 × 10⁵ CFU/ml | none | S. aureus (ATCC #27660) | 8 mm |
| 4-3 | Nitrile Substrate | 1.6 × 10⁵ CFU/ml | none | S. aureus (ATCC #27660) | 8 mm |
| 5-1 | Nitrile Substrate | 1.6 × 10⁵ CFU/ml | none | S. aureus (ATCC #27660) | 8 mm |
| 5-2 | Nitrile Substrate | 1.6 × 10⁵ CFU/ml | none | S. aureus (ATCC #27660) | 8 mm |
| 5-3 | Nitrile Substrate | 1.6 × 10⁵ CFU/ml | none | S. aureus (ATCC #27660) | 8 mm |
| | Positive Control - Nitrile Glove; Silicone Solution. | 1.6 × 10⁵ CFU/ml | 1 mm | S. aureus (ATCC #27660) | 8 mm |
| | Dripped/Dried; Anitmicrobial Solution Applied | | | | |
| | Negative Control - Nitrile Glove; | 1.6 × 10⁵ CFU/ml | none | S. aureus (ATCC #27660) | 8 mm |

TABLE 1B
“Wet-leaching” ASTM E-2149-01 Protocol Used

| Sample # | description | Inoculum Level | Zone of Inhibition | Test Organism | Sample Size |
|---|---|---|---|---|---|
| 1-1 | Nitrile Substrate | 1.6 × 10⁵ CFU/ml | none | S. aureus (ATCC #27660) | 100 μl |
| 1-2 | Nitrile Substrate | 1.6 × 10⁵ CFU/ml | none | S. aureus (ATCC #27660) | 100 μl |
| 1-3 | Nitrile Substrate | 1.6 × 10⁵ CFU/ml | none | S. aureus (ATCC #27660) | 100 μl |
| 2-1 | Nitrile Substrate | 1.6 × 10⁵ CFU/ml | none | S. aureus (ATCC #27660) | 100 μl |
| 2-2 | Nitrile Substrate | 1.6 × 10⁵ CFU/ml | none | S. aureus (ATCC #27660) | 100 μl |
| 2-3 | Nitrile Substrate | 1.6 × 10⁵ CFU/ml | none | S. aureus (ATCC #27660) | 100 μl |
| 3-1 | Nitrile Substrate | 1.6 × 10⁵ CFU/ml | none | S. aureus (ATCC #27660) | 100 μl |
| 3-2 | Nitrile Substrate | 1.6 × 10⁵ CFU/ml | none | S. aureus (ATCC #27660) | 100 μl |
| 3-3 | Nitrile Substrate | 1.6 × 10⁵ CFU/ml | none | S. aureus (ATCC #27660) | 100 μl |
| 4-1 | Nitrile Substrate | 1.6 × 10⁵ CFU/ml | none | S. aureus (ATCC #27660) | 100 μl |
| 4-2 | Nitrile Substrate | 1.6 × 10⁵ CFU/ml | none | S. aureus (ATCC #27660) | 100 μl |
| 4-3 | Nitrile Substrate | 1.6 × 10⁵ CFU/ml | none | S. aureus (ATCC #27660) | 100 μl |
| 5-1 | Nitrile Substrate | 1.6 × 10⁵ CFU/ml | none | S. aureus (ATCC #27660) | 100 μl |
| 5-2 | Nitrile Substrate | 1.6 × 10⁵ CFU/ml | none | S. aureus (ATCC #27660) | 100 μl |
| 5-3 | Nitrile Substrate | 1.6 × 10⁵ CFU/ml | none | S. aureus (ATCC #27660) | 100 μl |
| | Positive Control - Amphyl (0.5% v:V) | 1.6 × 10⁵ CFU/ml | 5 mm | S. aureus (ATCC #27660) | 100 μl |
| | Negative Control - Nitrile Substrate; | 1.6 × 10⁵ CFU/ml | none | S. aureus (ATCC #27660) | 100 μl |

TABLE 2
“RAPID GERMICIDAL CONTACT-TRANSFER TEST”

| | Organism Count (CFU/ml) | | | | | | | |
|---|---|---|---|---|---|---|---|---|
| | Zero Time | 3 Min. | 5 Min. | 30 Min. | % Reduction | | | |
| Sample # | Point | Time Point | Time Point | Time Point | 0 hr. | 3 Min. | 5 Min. | 30 Min. |
| #1 - Nitrile Substrate | 3.8 × 10³ | 1.5 × 10² | ND | — | 96.8% | 99.9% | 99.99% | — |
| #2 - Nitrile Substrate | 1.2 × 10³ | 10 | ND | — | 99% | 99.99% | — | — |
| #3 - Nitrile Substrate | 4.6 × 10³ | 40 | ND | — | 96.2% | 99.97% | 99.99% | — |
| #4 - Nitrile Substrate | 3.6 × 10³ | 5.1 × 10² | ND | — | 97% | 99.6% | 99.99% | — |
| #5 - Nitrile Substrate | 4.7 × 10³ | 70 | ND | — | 96.1% | 99.9% | 99.99% | — |
| #6 - Control - Nitrile Glove; | 1.2 × 10⁵ | 1.4 × 10⁵ | 1.3 × 10⁵ | 1.4 × 10⁵ | — | NR | NR | NR |

We claim:

1. A elastomeric article comprising a first surface having a stably associated, non-leaching antimicrobial coating over at least a portion of said first surface, and said antimicrobial coating experiences no loss of the antimicrobial molecules from said coated first surface when subject to a testing regime involving a first version or a second version, or both versions of a zone of inhibition test.

2. The elastomeric article according to claim 1, wherein said elastomeric article generates no zones of inhibition when subject to said first and second versions of said zone of inhibition test.

3. The elastomeric article according to claim 1, wherein said first version involves a dry-leaching test protocol, and said second version involves a wet-leaching test protocol.

4. The elastomeric article according to claim 1, wherein said elastomeric article demonstrates a level of biocide efficacy that produces a reduction in the concentration of microbes on said first surface by a magnitude of at least log₁₀ 1, when subject to a rapid germicidal test protocol.

5. The elastomeric article according to claim 4, wherein said reduction in the concentration of microbes on said first surface by a magnitude of at least log₁₀ 3.

6. The elastomeric article according to claim 4, wherein said reduction in the concentration of microbes on said first surface by a magnitude of log₁₀ 4.

7. An elastomeric article comprising an elastomeric substrate having a first surface, an antimicrobial composition bound to said first surface forming a substantive or non-fugative antimicrobial coating over at least a portion of said first surface, in a manner such that when said antimicrobial coating is subject to a either a) a first version involving a dry-leaching or agar-plate-based test, according to AATCC 147 protocol, or b) a second version involving a wet-leaching or dynamic shake flask test according to ASTM E-2149-01 protocol, or c) both versions of a zone of inhibition test, said antimicrobial coating produces no zones of inhibition.

8. The elastomeric article according to claim 7, wherein said substrate is further subject to a rapid germicidal test of relatively short duration, and said antimicrobial coating exhibits a level of biocide efficacy that produces a reduction in the concentration of microbes that may be transferred onto said first surface by a magnitude of at least log₁₀ 1.

9. The elastomeric article according to claim 7, wherein when an indicator dye, tetrabromofluorescein (Eosin Yellowish), is applied to an antimicrobial-treated surface of said glove, said antimicrobial coated surface of said glove turns a reddish color.

10. A method for creating a non-leaching antimicrobial coating on a surface of an elastomeric substrate, the method comprises: providing an elastomeric substrate having at least a first surface; provide an antimicrobial solution containing an anti-foaming agent and heated to a temperature of at least about 40.5° C. (˜105° F.); applying said antimicrobial agent in an application apparatus by means of either spraying with a nozzle atomizer, or immersing in an agitated bath of said antimicrobial solution for an effective amount of time to substantively bind said antimicrobial coating to said substrate.

11. The method according to claim 10, wherein said elastomeric substrate has a body made from either a natural or synthetic polymer latex.

12. The method according to claim 10, wherein said antimicrobial solution is heated to a temperature of about 43° C. (˜10° F.) to about 82.2° C. (˜180° F.).

13. The method according to claim 10, wherein when using said nozzle atomizer, said solution is sprayed at a delivery air pressure of about 30-50 psi (206.84 kPa-344.74 kPa) and liquid flow of about 1.25 to 5.5 psi (8.62 kPa-37.92 kPa) to said first surface of the substrate while said substrate is tumbled in a heated chamber.

14. The method according to claim 13, wherein said air pressure is about 40 psi aerosol and said liquid flow rate of the solution is about 2-4.75 psi.

15. The method according to claim 13, wherein said chamber is heated to a temperature of about 60° C. (˜140° F.) to about 82.2° C. (1180° F.).

16. The method according to claim 10, wherein said heated chamber is a rotary drum.

17. The method according to claim 10, wherein when using said bath of said antimicrobial solution, the solution is heated to a temperature of about 40.5° C. (105° F.) to about 75° C. (˜167° F.).

18. The method according to claim 10, wherein said elastomeric article is subject to said application step for an effective amount of time of at least about 12 minutes.

19. The method according to claim 18, wherein said elastomeric article is treated for at least about 15 to 20 minutes.

20. The method according to claim 10, wherein either said heating of said antimicrobial solution or said heat treatment application, or a combination of both promotes a more efficient binding of said antimicrobial agent with said substrate.

21. The method according to claim 10, wherein said antimicrobial agent is at least one of the following: a quaternary ammonium compound, a polyquaternary amine, halogens, a halogen-containing polymer, a bromo-compound, a chlorine dioxide, a chlorhexidine, a thiazole, a thiocynate, an isothiazolin, a cyanobutane, a dithiocarbamate, a thione, a triclosan, an alkylsulfosuccinate, an alkyl-amino-alkyl glycine, a polyhexamethylene biguanide, a dialkyl-dimethyl-phosphonium salt, a cetrimide, hydrogen peroxide, 1-alkyl-1,5-diazapentane, or cetyl pyridinium chloride.

22. An elastomeric article having an antimicrobial coating, the article comprises: a body formed of a natural or synthetic polymer latex having an outer surface and an inner surface; said body having a coating of an antimicrobial agent over at least a portion of said outer surface, and said antimicrobial coating experiences no loss of the antimicrobial molecules from said coated first surface when subject to a testing regime involving a first version or a second version, or both versions of a zone of inhibition test, and wherein said substrate is further subject to a rapid contact-transfer test of relatively short durations, and said antimicrobial coating exhibits a level of biocide efficacy that produces a reduction in the concentration of microbes that may be transferred onto said first surface by a magnitude of at least log₁₀ 1.

23. The elastomeric article according to claim 22, wherein said article is a glove or condom.

24. The elastomeric article according to claim 23, wherein said article is a glove for medical or surgical uses.

25. The elastomeric article according to claim 22, wherein said article has a micro-textured surface.

26. An elastomeric article having reducing microbe affinity and transmission, the article comprising: a non-leaching antimicrobial coating stably associated with a surface of an elastomeric substrate, said coating having being applied either through a heated spray coating device having at least one nozzle atomizer or a heated immersion bath, wherein said antimicrobial coating experiences no loss of the antimicrobial molecules from said coated first surface when subject to a testing regime involving a first version or a second version, or both versions of a zone of inhibition test, and wherein said substrate is further subject to a rapid germicidal test of relatively short duration, and said antimicrobial coating exhibits a level of biocide efficacy that produces a reduction in the concentration of microbes that may be transferred onto said first surface by a magnitude of at least log₁₀ 1.

27. The elastomeric article according to claim 26, wherein said antimicrobial solution containing an antifoaming agent is heated to a temperature of about 50° C. to about 70° C., and when said heated antimicrobial solution applied through said nozzle atomizer at a delivery air pressure of about 30 psi to about 50 psi (˜206.84 kPa-344.74 kPa) and liquid flow of about 1.25 psi to about 5.5 psi (˜8.62 kPa-37.92 kPa) to said first surface of said elastomeric substrate while said substrate is tumbled in a heated chamber.

28. The elastomeric article of claim 26, wherein the article comprises from about 0.05% to about 10% by mass antimicrobial polymer.

29. The elastomeric article of claim 28, wherein the article comprises from about 2% to about 5% by mass antimicrobial polymer.

30. The elastomeric article of claim 26, wherein said elastomeric substrate is selected from natural rubber latex, synthetic polymer latex, styrene-ethylene-butylene-styrene (SEBS), or styrene-butadiene-styrene (SBS) copolymer materials.
